(19) United States
(12) Patent Application Publication
(10) Pub. No.: US 2006/0084775 A1
(43) Pub. Date: Apr. 20, 2006

(54) Coating material composition stable to hydrolysis

(76) Inventors: Thorsten Rische, Unna (DE); Gerald Kurek, Leverkusen (DE); Jurgen Meixner, Krefeld (DE); Torsten Pohl, Leverkusen (DE); Uwe Klippert, Burscheid (DE); Thomas Feller, Solingen (DE)

Correspondence Address: BAYER MATERIAL SCIENCE LLC, 100 BAYER ROAD, PITTSBURGH, PA, 15205, US

(21) Appl. No.: 11/227,933

(22) Filed: Sep. 15, 2005

(30) Foreign Application Priority Data
Sep. 20, 2004 (DE) 102004045533.3

(51) Int. Cl. C08G 18/00

(52) U.S. Cl. 528/44

(57) ABSTRACT

The invention relates to aqueous coating material compositions stable to hydrolysis, to a process for preparing them and to their use as soft feel paint. The compositions comprise hydroxyl-free polyurethanes and/or polyurethane-ureas based on polycarbonate polyols and polytetramethylene glycol polyols, ionically modified, hydroxyl- and/or amino-containing polyurethanes and/or polyurethane-ureas and at least one crosslinker, and optionally further film-forming resins.

### FIELD OF THE INVENTION

This application claims priority on German application 10 2004 045 533, filed Sep. 20, 2004. The invention relates to aqueous coating material compositions stable to hydrolysis, to a process for preparing them and to their use as soft feel paint.

### BACKGROUND OF THE INVENTION

Polyurethane-polyurea dispersions (PU dispersions) and aqueous preparations of PU dispersions are known state of the art. One important field of use of aqueous preparations of ionically modified PU dispersions is in the area of the painting of plastics parts.

Aesthetic and technical requirements mean that plastics parts are usually painted in order to protect the plastic against external influences, such as sunlight, chemical, thermal and mechanical stress, to achieve particular colours and colour effects, to mask defects in the plastic's surface or to give the latter a pleasant feel (tactility). In order to improve the tactile properties of plastics parts, use has been made increasingly in recent years of what are called soft feel paints. “Soft feel effect” for the purposes of the present invention refers to a particular tactual sensation (tactility) of the painted surface; this tactility can be described using terms such as velvety, soft, rubbery and warm. In tune with the trend towards avoiding solvent emissions to the environment, recent years have seen the establishment of aqueous soft feel points based on polyurethane chemistry, as are disclosed, by way of example, in DE-A 44 06 159. As well as an excellent soft feel effect, these paints also produce coatings having good resistance and protection for the plastics substrate. It has since emerged, however, that these paints and coatings often have only an inadequate stability to hydrolysis.

The object of the present invention was therefore to provide coating materials which in addition to the abovementioned mechanical and tactile properties lead, in comparison to prior art coating materials, to coatings possessing significantly greater stability to hydrolysis.

As described for example in DE-A 44 06 159, plastics coating materials having the desired tactile soft feel properties are composed in part of PU dispersions containing no notable amounts of hydroxyl-functional groups.

DE-A 101 22 444 describes ionically and/or nonionically hydrophilicized polyurethane-polyurea (PU) dispersions that are stable to hydrolysis and are based on polycarbonate polyols and polytetramethylene glycol polyols. On a wide variety of substrates, in one-component coating materials, the dispersions lead to crease- and scratch-resistant coatings that are stable to hydrolysis. Use of these dispersions as soft feel paints, however, is not described.

### SUMMARY OF THE INVENTION

It has now been found that aqueous two-component (2 K) coating materials which comprise not only non-functional PU polymers based on polycarbonate polyols and polytetramethylene glycol polyols but also hydrophilic, hydroxyl-containing PU polymers exhibit outstanding stability to hydrolysis and at the same time display the desired tactile properties.

The present invention accordingly provides aqueous coating materials comprising
I) hydroxyl-free polyurethanes and/or polyurethane-ureas based on polycarbonate polyols and polytetramethylene glycol polyols,
II) ionically modified, hydroxyl- and/or amino-containing polyurethanes and/or polyurethane-ureas and
(III) at least one crosslinker, and
(IV) optionally further film-forming resins.

### DETAILED DESCRIPTION OF PREFERRED EMBODIMENTS

As used herein, as used in the examples or unless otherwise expressly specified, all numbers may be read as if prefaced by the word “about”, even if the term does not expressly appear. Also, any numerical range recited herein is intended to include all sub-ranges subsumed therein.

The non-functional PU polymers (I) and also the hydroxyl- and/or amino-functional crosslinkable PU polymers (II) comprise compounds selected from groups I.1) to I.6) and II.1) to II.6) respectively:
I.1)/II.1) polyisocyanates,
I.2) mixture of polycarbonate polyols and polytetramethylene glycol polyols having number-average molecular weights of 200 to 8000 g/mol,
II.2) polymeric polyols having a number-average molecular weight of 200 to 8000 g/mol,
I.3)/II.3) low molecular weight compounds of molar weight 62 to 400 possessing in total two or more hydroxyl and/or amino groups,
I.4)/II.4) compounds possessing one hydroxyl or amino group,
I.5)/II.5) isocyanate-reactive, ionically or potentially ionically hydrophilicizing compounds,
I.6)/II.6) isocyanate-reactive nonionically hydrophilicizing compounds.

Suitable polyisocyanates of component I.1) and II.1) are the aromatic, araliphatic, aliphatic or cycloaliphatic polyisocyanates which are known per se to the skilled person, have an NCO functionality of preferably ≧2 and may also contain iminooxadiazinedione, isocyanurate, uretdione, urethane, allophanate, biuret, urea, oxadiazinetrione, oxazolidinone, acylurea and/or carbodiimide structures. They may be used individually or in any desired mixtures of one another.

Examples of suitable polyisocyanates are butylene diisocyanate, hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl) methanes or mixtures thereof with any desired isomer content, isocyanatomethyl-1,8-octane diisocyanate, 1,4-cyclohexylene diisocyanate, 1,4-phenylene diisocyanate, 2,4- and/or 2,6-toluylene diisocyanate, 1,5-naphthylene diisocyanate, 2,4′- or 4,4′-diphenylmethane diisocyanate, triphenylmethane-4,4′,4″-triisocyanate or derivatives based on the asforementioned diisocyanates with a uretdione, isocyanurate, urethane, allophanate, biuret, iminooxadiazinedione and/or oxadiazinetrione structure and with more than 2 NCO groups, as are described exemplarily in J. Prakt. Chem. 336 (1994) pp. 185-200.

An example of a non-modified polyisocyanate having more than 2 NCO groups per molecule that may be mentioned is, for example, 4-isocyanatomethyl-1,8-octane diisocyanate (nonane triisocyanate).

Preference is given to polyisocyanates or polyisocyanate mixtures of the aforementioned kind that contain exclusively aliphatically and/or cycloaliphatically attached isocyanate groups.

Particular preference is given to hexamethylene diisocyanate, isophorone diisocyanate, the isomeric bis(4,4′-isocyanatocyclohexyl) methanes and also mixtures thereof.

The PU polymers (I) comprise as component I.2) a mixture of polycarbonate polyols and polytetramethylene glycol polyols. The fraction of polycarbonate polyols in the mixture is between 20% and 80% by weight and the fraction of polytetramethylene glycol polyols is between 80% and 20% by weight. Preference is given to a fraction of 30% to 75% by weight of polytetramethylene glycol polyols and a fraction of 25% to 70% by weight of polycarbonate polyols. Particular preference is given to a fraction of 35% to 70% by weight of polytetramethylene glycol polyols and a fraction of 30% to 65% by weight of polycarbonate polyols, in each case with the proviso that the sum of the weight percentages of the polycarbonate polyols and polytetramethylene glycol polyols makes 100%.

The polyols specified under I.2) have an OH functionality of at least 1.8 to 4. Preference is given to using polyols in a middle molar weight range of 200 to 8000 with an OH functionality of 2 to 3. Particularly preferred polyols are those having average molecular weight ranges of 200 to 3000.

Suitable polytetramethylene glycol polyols are polytetramethylene glycol polyethers, which may be prepared, for example, via polymerization of tetrahydrofuran, by cationic ring-opening.

Hydroxyl-containing polycarbonate polyols meeting the definition of component I.2) are obtainable by reacting carbonic acid derivatives, e.g. diphenyl carbonate, dimethyl carbonate or phosgene, with diols.

Examples of suitable such diols include ethylene glycol, 1,2- and 1,3-propanediol, 1,3- and 1,4-butanediol, 1,6-hexanediol, 1,8-octanediol, 1,12-dodecanediol, neopentyl glycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenol A, tetrabromobisphenol A or else lactone-modified diols. Preferably the diol component contains 40% to 100% by weight of hexanediol, preferably 1,6-hexanediol and/or hexanediol derivatives, with particular preference being given to those derivatives which in addition to terminal OH groups contain ether or ester groups, such as products obtained by reacting 1 mol of hexanediol with at least 1 mol, preferably 1 to 2 mol, of caprolactone or by etherifying hexanediol with itself to form the di- or trihexylene glycol. The preparation of such derivatives is known, for example, from DE-A 15 70 540. The polyether-polycarbonate diols described in DE-A 37 17 060, as well, can be used.

The hydroxyl polycarbonates are preferably linear, but may also be branched where appropriate as a result of the incorporation of polyfunctional components, particularly low molecular weight polyols. Examples of those suitable for this purpose include glycerol, trimethylolpropane, hexane-1,2,6-triol, butane-1,2,4-triol, trimethylolpropane, pentaerythritol, quinitol, mannitol and sorbitol or methylglycoside and 1,3,4,6-dianhydrohexitols.

Polyester polyols which can be used as compounds II.2) preferably have a molecular weight Mn of 400 to 6000, more preferably of 600 to 3000. Their hydroxyl number is generally 22 to 400, preferably 50 to 200 and more preferably 80 to 160 mg/KOH/g, and they have an OH functionality of 1.5 to 6, preferably of 1.8 to 3 and more preferably of 2.

Highly suitable examples are the conventional polycondensates of diols and also optionally poly(tri,tetra)ols and dicarboxylate and also optionally poly(tri,tetra)carboxylic acids or hydroxycarboxylic acids or lactones. Instead of the free polycarboxylic acids it is also possible to use the corresponding polycarboxylic anhydrides or corresponding polycarboxylic esters of lower alcohols to prepare the polyesters. Examples of suitable diols are ethylene glycol, butylene glycol, diethylene glycol, triethylene glycol, polyalkylene glycols such as polyethylene glycol, and also propanediol, butane-1,4-diol, hexane-1,6-diol, neopentyl glycol or neopentyl glycol hydroxypivalate, preference being given to the three last-mentioned compounds. As polyols for optional use as well, mention may be made here, for example, of trimethylolpropane, glycerol, erythritol, pentaerythritol, trimethylolbenzene or trishydroxyethylisocyanurate.

Examples of suitable dicarboxylic acids include phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, subeiric acid, 2-methylsuccinic acid, 3,3-diethylglutaric acid and 2,2-dimethylsuccinic acid. Anhydrides of these acids can also be used, where they exist. For the purposes of the present invention, consequently, the anhydrides are embraced by the term “acid”. Monocarboxylic acids as well, such as benzoic acid and hexanecarboxylic acid, can be used provided that the average functionality of the polyol is greater than 2. Saturated aliphatic or aromatic acids are preferred, such as adipic acid or isophthalic acid. As a polycarboxylic acid which can also be used optionally, in relatively small amounts, mention may be made here of trimellitic acid.

Hydroxycarboxylic acids which can be used as reaction participants for the preparation of a polyester polyol with terminal hydroxyl are, for example, hydroxycaproic acid, hydroxybutyric acid, hydroxydecanoic acid, hydroxystearic acid and the like. Lactones which can be used include caprolactone, butyrolactone and the like.

Compounds of component II.2) may at least proportionally also contain primary or secondary amino groups as NCO-reactive groups.

Suitable compounds II.2) are likewise hydroxyl-containing polycarbonates with a molecular weight Mn of 400 to 6000, preferably 600 to 3000, which are obtainable, for example, by reacting carbonic acid derivatives, e.g. diphenylcarbonate, dimethylcarbonate or phosgene, with polyols, preferably diols. Examples of suitable such diols include ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenol A, tetrabromobisphenol A or else lactone-modified diols. Preferably the diol component contains 40% to 100% by weight of hexanediol, preferably 1,6-hexanediol and/or hexanediol derivatives, preferably those which in addition to terminal OH groups contain ether groups or ester groups, examples being products obtained by reacting 1 mol of hexanediol with at least 1 mol, preferably 1 to 2 mol, of caprolactone or by etherifying hexanediol with itself to give the di- or trihexylene glycol. Polyether-polycarbonate diols as well can be used. The hydroxyl polycarbonates ought to be substantially linear. However, where appropriate, they may be slightly branched as a result of the incorporation of polyfunctional components, particularly low molecular weight polyols. Examples of compounds suitable for this purpose include glycerol, trimethylolpropane, hexane-1,2,6-triol, butane-1,2,4-triol, trimethylolpropane, pentaerythritol, quinitol, mannitol, sorbitol, methylglycoside or 1,3,4,6-dianhydrohexitols.

Suitable polyether polyols meeting the definition of compounds II.2) are the polytetramethylene glycol polyethers that are known per se in polyurethane chemistry and can be prepared, for example, via polymerization of tetrahydrofuran, by cationic ring-opening.

Additionally suitable polyether polyols are polyethers, such as the polyols of styrene oxide, ethylene oxide, propylene oxide, butylene oxides or epichloohydrin, and particularly of propylene oxide, that are prepared using starter molecules.

Preference is given to using polyester polyols and/or polycarbonate polyols.

The low molecular weight polyols I.3) or II.3) that are used for synthesizing the polyurethane resins generally have the effect of a stiffening and/or a branching of the polymer chain. The molecular weight is preferably situated between 62 and 200. Suitable polyols may contain aliphatic, alicyclic or aromatic groups. Mention may be made here, by way of example, of the low molecular weight polyols having up to about 20 carbon atoms per molecule, such as ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, hydroquinone di-hydroxyethylether, bisphenol A (2,2-bis(4-hydroxyphenyl)propane), hydrogenated bisphenol A (2,2-bis(4-hydroxycyclo-hexyl)propane) and also mixtures thereof, and also trimethylolpropane, glycerol or pentaerythritol. Ester diols as well, such as δ-hydroxybutyl ε-hydroxycaproic ester, ω-hydroxyhexyl γ-hydroxybutyric ester, (β-hydroxyethyl) adipate or bis(β-hydroxyethyl) terephthalate, can be used.

Diamines or polyamines and also hydrazides can likewise be used as I.3) or II.3), examples being ethylenediamine, 1,2- and 1,3-diaminopropane, 1,4-diaminobutane, 1,6-diaminohexane, isophoronediamine, an isomer mixture of 2,2,4- and 2,4,4-trimethylhexamethylenediamine, 2-methylpentamethylene-diamine, diethylenetriamine, 1,3- and 1,4-xylylenediamine, α,α,α′,α′-tetra-methyl-1,3- and -1,4-xylylenediamine and 4,4-diaminodicyclohexylmethane, dimethylethylenediamine, hydrazine or adipic dihydrazide.

Suitability as I.3) or II.3) is also possessed in principle by compounds containing active hydrogen with a different reactivity towards NCO groups, such as compounds which in addition to a primary amino group also contain secondary amino groups, or in addition to an amino group (primary or secondary) also contain OH groups. Examples of such are primary/secondary amines, such as 3-amino-1-methylaminopropane, 3-amino-1-ethylaminopropane, 3-amino-1-cyclohexylaminopropane, 3-amino-1-methylaminobutane, and also alkanolamines such as N-aminoethylethanolamine, ethanolamine, 3-aminopropanol, neopentanol-amine and, with particular preference, diethanolamine. In the case of use for preparing the PU dispersion (I) these are used as chain extenders and in the case of use for preparing the PU dispersion (II) they are used as chain termination.

The polyurethane resin may also, where appropriate, include units I.4) and/or II.4), which in each case are located at the chain ends and finish the said ends. These units are derived on the one hand from monofunctional compounds reactive towards NCO groups, such as monoamines, particularly mono-secondary amines or monoalcohols. Examples that may be mentioned here include the following: ethanol, n-butanol, ethylene glycol monobutyl ether, 2-ethylhexanol, 1-octanol, 1-dodecanol, 1-hexadecanol, methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine, and suitable substituted derivatives thereof, amide-amines formed from diprimary amines and monocarboxylic acids, monoketimes of diprimary amines, primary/tertiary amines, such as N,N-dimethylaminopropylamine and the like.

By ionically and potentially ionically hydrophilicizing compounds I.5) and II.5) are meant all compounds which contain at least one isocyanate-reactive group and also at least one functionality, such as —COOY, —SO₃Y, —PO(OY)₂ (Y for example ═H, NH₄⁺, metal cation), —NR₂, —NR₃⁺ (R═H, alkyl, aryl), which on interaction with aqueous media enters into a pH-dependent dissociation equilibrium and in that way can have a negative, positive or neutral charge. Preferred isocyanate-reactive groups are hydroxyl or amino groups.

Suitably ionically or potentially ionically hydrophilicizing compounds meeting the definition of component I.5) or II.5) are, for example, mono- and dihydroxycarboxylic acids, mono- and diaminocarboxylic acids, mono- and dihydroxysulphonic acids, mono- and diaminosulphonic acids and also mono- and dihydroxyphosphonic acids or mono- and diaminophosphonic acids and their salts such as dimethylolpropionic acid, dimethylolbutyric acid, hydroxypivalic acid, N-(2-aminoethyl)-β-alanine, 2-(2-aminoethylamino)ethanesulphonic acid, ethylene-diaminepropylsulphonic or -butylsulphonic acid, 1,2- or 1,3-propylenediamine-β-ethylsulphonic acid, malic acid, citric acid, glycolic acid, lactic acid, glycine, alanine, taurine, lysine, 3,5-diaminobenzoic acid, an adduct of IPDI and acrylic acid (EP-A 0 916 647, example 1) and the alkali metal and/or ammonium salts thereof; the adduct of sodium bisulphite with but-2-ene-1,4-diol, polyethersulphonate, the propoxylated adduct of 2-butenediol and NaHSO₃, described for example in DE-A 2 446 440 (page 5-9, formula I-III), and compounds which contain units which can be converted into cationic groups, amine-based units for example, such as N-methyldiethanolamine, as hydrophilic synthesis components. It is additionally possible to use cyclohexylamino-propanesulphonic acid (CAPS) such as in WO-A 01/88006, for example, as a compound meeting the definition of component I.5) or II.5).

Preferred ionic or potential ionic compounds I.5) are those which possess carboxyl or carboxylate and/or sulphonate groups and/or ammonium groups. Particularly preferred ionic compounds I.5) are those containing carboxyl and/or sulphonate groups as ionic or potentially ionic groups, such as the salts of N-(2-aminoethyl)-β-alanine, of 2-(2-aminoethylamino)ethanesulphonic acid or of the adduct of IPDI and acrylic acid (EP-A 0 916 647, example 1) and also of dimethylolpropionic acid.

Preferred ionic or potential ionic compounds II.5) are those which posses carboxyl and/or carboxylate groups. Particularly preferred ionic compounds II.5) are dihydroxycarboxylic acids, very particular preference being given to α,α-dimethylolalkanoic acids, such as 2,2-dimethylolacetic acid, 2,2-dimethylol-propionic acid, 2,2-dimethylolbutyric acid, 2,2-dimethylolpentanoic acid or dihydroxysuccinic acid.

Suitable non-ionically hydrophilicizing compounds meeting the definition of component I.6) or II.6) are, for example, polyoxyalkylene ethers which contain at least one hydroxyl or amino group. These polyethers include a fraction of 30% to 100% by weight of units derived from ethylene oxide.

Non-ionically hydrophilicizing compounds also include, for example, monohydric polyalkylene oxide polyether alcohols containing on average 5 to 70, preferably 7 to 55, ethylene oxide units per molecule, such as are obtainable in conventional manner by alkoxylating appropriate starter molecules (e.g. in Ullmanns Encyclopädie der technischen Chemie, 4th edition, volume 19, Verlag Chemie, Weinheim pp. 31-38).

Examples of suitable starter molecules are saturated monoalcohols such as methanol, ethanol, n-propanol, isopropanol, n-butanol, isobutanol, sec-butanol, the isomers pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyl-oxetane or tetrahydrofurfuryl alcohol, diethylene glycol monoalkyl ethers, such as diethylene glycol monobutyl ether, for example, unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol, secondary monoamines such as dimethylamine, diethylamine, dipropylamine, diisopropylamine, dibutylamine, bis-(2-ethylhexyl)amine, N-methyl- and N-ethylcyclohexylamine or dicyclohexyl-amine and also heterocyclic secondary amines such as morpholine, pyrrolidine, piperidine or 1H-pyrazole. Preferred starter molecules are saturated monoalcohols. Particular preference is given to using diethylene glycol monobutyl ether as a starter molecule.

Alkylene oxides suitable for the alkoxylation reaction are, in particular, ethylene oxide and propylene oxide, which may be used in any order or else as a mixture in the alkoxylation reaction.

The polyalkylene oxide polyether alcohols are either straight polyethylene oxide polyethers or mixed polyalkylene oxide polyethers at least 30 mol %, preferably at least 40 mol %, of whose alkylene oxide units are composed of ethylene oxide units. Preferred non-ionic compounds are monofunctional mixed polyalkylene oxide polyethers containing at least 40 mol % ethylene oxide units and not more than 60 mol % propylene oxide units.

For the PU polymers (I) it is preferred to use a combination of ionic and non-ionic hydrophilicizing agents meeting the definitions of components I.5) and I.6). Particularly preferred combinations are those of non-ionic and anionic hydrophilicizing agents.

The PU polymers (II) preferably exhibit a pure ionic hydrophilicization in accordance with the definition of components II.5).

It is preferred to use 5% to 45% by weight of component I.1), 50% to 90% by weight of component I.2), 1% to 30% by weight of the sum of compounds I.3) and I.4), 0 to 12% by weight of component I.5), 0 to 15% by weight of component I.6), the sum of I.5) and I.6) being 0.1% to 27% by weight and the sum of all components adding to 100% by weight.

It is particularly preferred to use 10% to 40% by weight of component I.1), 60% to 85% by weight of component I.2), 1% to 25% by weight of the sum of compounds I.3) and I.4), 0 to 10% by weight of component I.5), 0 to 10% by weight of component I.6), the sum of I.5) and I.6) being 0.1% to 20% by weight and the sum of all components adding to 100% by weight.

Very particular preference is given to using 15% to 40% by weight of component I.1), 60% to 82% by weight of component I.2), 1% to 20% by weight of the sum of compounds I.3), 0 to 8% by weight of component I.5), 0 to 10% by weight of component I.6), the sum of I.5) and I.6) being 0.1% to 18% by weight and the sum of all components adding to 100% by weight.

The coating materials of the invention comprise PU polymers (I) which are used in the form of their aqueous PU dispersion (I).

The process for preparing the aqueous PU dispersion (I) can be carried out in one or more stages in homogenous phase or, in the case of multi-stage reaction, partly in disperse phase. Following complete or partial polyaddition of I.1)-I.6) there is a dispersing, emulsifying or dissolving step. This is followed optionally by a further polyaddition or modification in disperse phase.

The aqueous PU dispersions (I) can be prepared using all of the prior art methods, such as the prepolymer mixing method, acetone method or melt dispersing method, for example. The PU dispersion (I) is prepared preferably by the acetone method.

For the preparation of the PU dispersion (I) by the acetone method the constituents I.2) to I.6), which should not contain any primary or secondary amino groups, and the polyisocyanate component I.1), for the preparation of an isocyanate-functional polyurethane prepolymer, are usually introduced in whole or in part as an initial charge and are diluted optionally with a solvent which is water-miscible but inert towards isocyanate groups and heated to temperatures in the range from 50 to 120° C. In order to accelerate the isocyanate addition reaction it is possible to use the catalysts that are known in polyurethane chemistry. Dibutyltin dilaurate is preferred.

Suitable solvents are the usual aliphatic, keto-functional solvents such as acetone or butanone, for example, which can be added not only at the beginning of the preparation but also in portions later on if desired. Acetone and butanone are preferred.

Subsequently any constituents from I.1)-I.6) that may not have been added at the beginning of the reaction are metered in.

In the case of the preparation of the polyurethane prepolymer the molar ratio of isocyanate groups to isocyanate-reactive groups is 1.0 to 3.5, preferably 1.1 to 3.0, more preferably 1.1 to 2.5.

The reaction of components I.1)-I.6) to form the prepolymer takes place partially or completely, but preferably completely. In this way polyurethane prepolymers containing free isocyanate groups are obtained, in bulk or in solution.

The preparation of the polyurethane prepolymers is followed or accompanied, if it has not already been carried out in the starting molecules, by partial or complete salt formation from the anionically and/or cationically dispersing groups. In the case of anionic groups this is done using bases such as tertiary amines, e.g. trialkylamines having 1 to 12, preferably 1 to 6, carbon atoms in each alkyl radical. Examples thereof are timethylamine, triethylamine, methyldiethylamine, tripropylamine and diisopropylethylamine. The alkyl radicals may, for example, also carry hydroxyl groups, as in the case of the dialkylmonoalkanolamines, alkyldialkanolamines and trialkanolamines. Neutralizing agents which can be used are optionally also inorganic bases, such as ammonia or sodium hydroxide and/or potassium hydroxide. Preference is given to triethylamine, triethanolamine, dimethylethanolamine or diisopropylethylamine.

The molar amount of the bases is between 50% and 100%, preferably between 70% and 100% of the molar amount of anionic groups. In the case of cationic groups, dimethyl sulphate or succinic acid is used. If only non-ionically hydrophilicized compounds I.6) containing ether groups are used, the neutralization step is omitted. Neutralization may also take place simultaneously with dispersing, with the dispersing water already containing the neutralizing agent.

Subsequently in a further step of the process, if it has not already taken place, or has taken place only partially, the resulting prepolymer is dissolved by means of aliphatic ketones such as acetone or butanone.

Thereafter, possible NH₂- and/or NH-functional components are reacted with the remaining isocyanate groups. This chain extension/termination may be carried out either in solvent prior to dispersing, during dispersing, or in water after the dispersing. Chain extension is preferably carried out prior to dispersing in water.

Where chain extension is carried out using compounds meeting the definition of I.5) and containing NH₂ or NH groups, the prepolymers are chain-extended preferably prior to dispersing.

The degree of chain extension, in other words the equivalent ratio of NCO-reactive groups of the compounds used for chain extension to free NCO groups of the prepolymer, is between 40% to 150%, preferably between 70% to 120%, more preferably between 80% to 120%.

The aminic components [I.3), I.4), I.5)] may optionally be used in water- or solvent-diluted form in the process of the invention, individually or in mixtures, with any sequence of the addition being possible in principle.

If water or organic solvents are also used as diluents then the diluent content is preferably 70% to 95% by weight.

The preparation of the PU dispersion (I) from the prepolymers takes place following chain extension. For that purpose either the dissolved and chain-extended polyurethane polymer is introduced into the dispersing water with strong shearing if desired, such as strong stirring, for example, or, conversely, the dispersing water is stirred into the prepolymer solutions. It is preferred to add the water to the dissolved prepolymer.

The solvent still present in the dispersions after the dispersing step is normally then removed by distillation. Removal actually during dispersing is likewise possible.

Depending on degree of neutralization and amount of ionic groups present, it is possible to make the dispersion very fine, so that it virtually has the appearance of a solution, although very coarse formulations are also possible, and are likewise sufficiently stable.

The solids content of the PU dispersion (I) is between 25% to 65%, preferably 30% to 60% and more preferably between 40% to 60%.

A further possibility is to modify the aqueous PU dispersions (I) by means of polyacrylates. For that purpose an emulsion polymerization of olefinically unsaturated monomers, examples being esters of (meth)acrylic acid and alcohols having 1 to 18 carbon atoms, styrene, vinyl esters or butadiene, is carried out within these polyurethane dispersions.

The coating materials of the invention comprise PU polymers (II), which in the course of preparation are either converted into the aqueous form, and are therefore present as a dispersion, or alternatively are present as a solution in a water-miscible solvent which is inert towards isocyanate groups.

The crosslinkable polyurethane polymers (II) can be prepared by the customary prior art processes. They contain carboxylic acid groups and/or sulphonic acid groups, preferably carboxylic acid groups, which may have been at least fractionally neutralized, as hydrophilic groups.

The compounds subsumed under components II.2) to II.6) may also include C═C double bonds, which may originate, for example, from long-chain aliphatic carboxylic acids or fatty alcohols. Functionalization with olefinic double bonds is also possible, for example, through the incorporation of allylic groups or of acrylic acid or methacrylic acid and also their respective esters.

The crosslinkable PU polymers (II) are normally prepared such that, first of all, an isocyanate-functional prepolymer is prepared from compounds meeting the definition of components II.1)-II.6) and, in a second reaction step, by reaction with compounds meeting the definition of components II.3), II.4) and II.5), in a non-aqueous medium, an OH- and/or NH-functional polyurethane is obtained, as described for example in EP-A 0 355 682, p. 4, 11.39-45. Alternatively the preparation can take place such that the polyurethane resin containing OH and/or NH groups is formed directly by reacting components II.1) to II.6) in a non-aqueous medium, as described for example in EP-A 0 427 028, p. 4, 1. 54-p. 5, 1. 1.

The compounds meeting the definition of component II.2) that are used for synthesizing this prepolymer can, but need not necessarily, be subjected to a distillation step beforehand under reduced pressure. For that purpose these compounds are distilled preferably continuously in a thin-film evaporator at temperatures ≧150° C., preferably at 170 to 230° C., more preferably at 180 to 220° C., under a reduced pressure of ≦10 mbar, preferably ≦2 mbar, more preferably ≦0.5 mbar. Low molecular weight, non-reactive volatile fractions are separated off under these conditions. In the course of the distillation, volatile fractions of 0.2% to 15% by weight, preferably 0.5% to 10% by weight, more preferably 1% to 6% by weight, are separated off.

Prepolymer preparation is normally carried out at temperatures of 0° to 140° C., depending on the reactivity of the isocyanate used. Components II.1) and II.2) are preferably used in such a way that the resulting NCO/OH ratio is 0.5 to 0.99/1, preferably 0.55 to 0.95/1 and more preferably 0.57 to 0.9/1.

In order to accelerate the urethanization reaction it is possible to use suitable catalysts, such as are known to the skilled person for the purpose of accelerating the NCO/OH reaction. Examples of such are tertiary amines such as trethylamine or diazobicyclooctane, organotin compounds such as dibutyltin oxide, dibutyltin dilaurate or tin bis(2-ethylhexanoate), for example, or other organometallic compounds.

Prepolymer preparation is preferably carried out in the presence of solvents that are inert towards isocyanate groups. Particularly suitable for this purpose are solvents which are compatible with water, such as ethers, ketones and esters and also N-methylpyrrolidone. The amount of this solvent advantageously does not exceed 30% by weight and is preferably situated in the range from 10% to 25% by weight, based in each case on the sum of polyurethane resin and solvent.

The acid groups incorporated in the prepolymer that is obtainable in this way are at least fractionally neutralized. This can be done during or else after prepolymer preparation but also during or after dispersing in water, by adding suitable neutralizing agents (see also with regard to PU dispersion (I)). An example of such is dimethylethanolamine, which serves preferably as neutralizing agent. The neutralizing agent is generally used in a molar ratio with respect to the acid groups of the prepolymer of 0.3:1 to 1.3:1, preferably of 0.4:1 to 1:1.

The neutralizing step is preferably carried out following prepolymer preparation, operating in principle at temperature of 0 to 80° C., preferably 40 to 80° C.

Thereafter the hydroxyl- and/or amino-functional polyurethane is converted into an aqueous dispersion by addition of water or by introduction into water.

The resins of the PU polymers (II) that are obtainable in accordance with the procedure described above possess a number-average molecular weight Mₙ of 1000 to 30 000, preferably of 1500 to 10 000, an acid number of 10 to 80, preferably of 15 to 40 mg KOH/g and an OH content of 0.5% to 6% by weight, preferably of 1.0% to 4%,

The PU dispersions (I) and (II) may comprise, as component I.7)/II.7), antioxidants and/or light stabilizers and/or other auxiliaries and additives.

As light stabilizers and antioxidants I.7) or II.7) it is possible optionally to use optionally all additives that are known for polyurethanes or polyurethane dispersions and are described for example in “Lichtschutzmittel für Lacke” (A. Valet, Vincentz Verlag, Hanover, 1996) and “Stabilization of Polymeric Materials” (H. Zweifel, Springer Verlag, Berlin, 1997). Preferred stabilizers are sterically hindered phenols (phenolic antioxidants) and/or sterically hindered amines based on 2,2,6,6-tetramethylenepiperidine (Hindered Amine Light Stabilizers, HALS-Light Stabilizers). It is further possible for all auxiliaries and additives that are known for PU dispersions, such as emulsifiers, defoamers and thickeners, for example, to be present in the PU dispersions. Finally it is also possible to incorporate fillers, plasticizers, pigments, carbon black sols and silica sols, aluminium dispersions, clay dispersions and asbestos dispersions into the PU dispersions.

Also present in the coating materials of the invention are crosslinkers III). Depending on the choice of crosslinker it is possible to prepare both one-component paints and two-component paints. By one-component paints for the purposes of the present invention are meant coating compositions wherein binder component and crosslinker component can be stored together without a crosslinking reaction taking place to any marked extent or any extent detrimental to the subsequent application. The crosslinking reaction takes place only at the time of application, following activation of the crosslinker. This activation can be brought about by means, for example, of an increase in temperature. By two-component paints are meant for the purposes of the present invention coating compositions wherein binder component and crosslinker component have to be stored in separate vessels owing to their high reactivity. The two components are mixed only shortly before application, when they react generally without additional activation. To accelerate the crosslinking reaction it is also possible, however, to use catalysts or to employ relatively high temperatures.

Examples of suitable crosslinkers III) include blocked or non-blocked polyisocyanate crosslinkers, amide- and amine-formaldehyde resins, phenolic resins, aldehyde resins and ketone resins, such as for example phenol-formaldehyde resins, resoles, furan resins, urea resins, carbamate resins, triazine resins, melamine resins, benzoguanamine resins, cyanamide resins, aniline resins, such as are described in “Lackkunstharze”, H. Wagner, H. F. Sarx, Carl Hanser Verlag Munich, 1971. Preference is given to polyisocyanates.

As crosslinkers of component III) it is particularly preferred to use polyisocyanates having free isocyanate groups, since the resultant aqueous polyurethane paints display a particularly high level of paint properties. Examples of suitable crosslinkers III) include 1-isocyanato-3,3,5-trimethyl-5-isocyanatomethylcyclohexane, hexamethylene diisocyanate, 1,4-diisocyanato-cyclohexane or bis(4-isocyanatocyclohexane)methane or 1,3-(bis-2-isocyanato-prop-2-yl)benzene or crosslinkers based on paint polyisocyanates such as polyisocyanates containing uretdione, biuret, isocyanurate or iminooxadiazine-dione groups and formed from hexamethylene diisocyanate, 1-isocyanato-3,3,5-trimethyl-5-isocyanatomethylcyclohexane or bis(4-isocyanatocyclohexane)-methane, or paint polyisocyanates containing urethane groups and based on 2,4- and/or 2,6-diisocyanatotoluene or 1-isocyanato-3,3,5-trimethyl-5-isocyanato-methyl-cyclohexane on the one hand and on low molecular weight polyhydroxyl compounds such as trimethylolpropane, the isomeric propanediols or butanediols, or any desired mixtures of such polyhydroxyl compounds, on the other.

Likewise provided by the present invention is a two-component paint comprising the coating materials of the invention.

Optionally it is possible for the said compounds containing free isocyanate groups to be converted into less reactive derivatives by reaction with blocking agents, these less reactive derivatives then undergoing reaction only following activation, at relatively high temperatures, for example. Examples of suitable blocking agents for these polyisocyanates are monohydric alcohols such as methanol, ethanol, butanol, hexanol, cyclohexanol, benzyl alcohol, oximes such as acetoxime, methyl ethyl ketoxime, cyclohexanone oxime, lactams such as ε-caprolactam, phenols, amines such as diisopropylamine or dibutylamine, dimethylpyrazole or triazole, and also dimethyl malonate, diethyl malonate or dibutyl malonate.

Very particular preference is given to the use of low-viscosity, hydrophobic or hydrophilicized polyisocyanates of the aforementioned kind containing free isocyanate groups and based on aliphatic, cycloaliphatic, araliphatic and/or aromatic isocyanates, preferably aliphatic or cycloaliphatic isocyanates, since in this way it is possible to achieve a particularly high level of resistance of the paint film. These polyisocyanates generally have a viscosity at 23° C. of 10 to 3500 mPas.

If necessary the polyisocyanates can be employed as a blend with small amounts of inert solvents in order to lower the viscosity to a level within the stated range. Triisocyanatononane as well can be used alone or in mixtures in component III).

The PU polymers I) and II) described here are generally sufficiently hydrophilic, so that the dispersibility even of hydrophobic crosslinkers from component III) is ensured. If desired, however, it is also possible to add external emulsifiers such as are known to the skilled person.

Additionally, however, it is also possible in component III) to use water-soluble or dispersible polyisocyanates such as are obtainable, for example, by modification with carboxylate, sulphonate and/or polyethylene oxide groups and/or polyethylene oxide/polypropylene oxide groups.

Also possible in principle, of course, is the use of mixtures of different crosslinker resins of the aforementioned kind in component III).

Suitability as further film-forming resins of component IV) is possessed by polymers which are soluble, emulsifiable or dispersible in water and which differ from the constituents of components I) to III). Examples thereof are optionally epoxide-group-containing polyesters, polyurethanes, acrylic polymers, vinyl polymers such as polyvinyl acetate, polyurethane dispersions, polyacrylate dispersions, polyurethane-polyacrylate hybrid dispersions, polyvinyl ether and/or polyvinyl ester dispersions, polystyrene dispersions and/or polyacrylonitrile dispersions. The solids content of the film-forming resins of component IV) is preferably 10% to 100% by weight, more preferably 30% to 100% by weight.

Likewise provided by the present invention is a process for preparing the aqueous coating materials of the invention, characterized in that the PU polymers (I) and also the PU polymers (II) are dispersed in water and mixed with the crosslinker (III) and optionally with the film-forming resins IV).

It is likewise possible for the PU polymers (II) to be present as a solution in a water-miscible solvent which is inert towards isocyanate groups and to be transferred to the aqueous phase by being introduced into the PU dispersion (I) and then to be mixed with the crosslinker (III) and optionally with the film-forming resins IV).

The ratio of the crosslinker III) to the compounds of components II) and optionally IV) that are reactive with it is to be chosen so as to result in a ratio of crosslinker-reactive groups from II) and IV) (e.g. OH groups) to the reactive groups of the crosslinker (NCO groups in the case of isocyanates) of 0.5:1.0 to 3.5:1.0, preferably 1.0:1.0 to 3.0:1.0 and more preferably of 1.0:1.0 to 2.5:1.0.

The mixture of components I), II) and IV) contains preferably 5% to 95% by weight, more preferably 25% to 75% by weight of component II), and the amounts of I) and IV) are to be chosen such that the total amounts of I), II) and IV) add up to 100% by weight.

As customary paint auxiliaries and additives, the substances known to the skilled person may be present in the coating materials of the invention, such as defoamers, thickeners, pigments, dispersing assistants, matting agents, catalysts, anti-skinning agents, anti-settling agents and/or emulsifiers, and also additives which enhance the desired soft feel effect. The point in time during preparation at which the additives/auxiliaries are added to the coating materials of the invention or incorporated into them is unimportant.

The aqueous coating materials of the invention are suitable for all fields of use in which aqueous painting and coating systems subject to stringent requirements on the surface quality/resistance of the films are employed, such as the coating of surfaces of mineral building materials, the painting and sealing of wood and wood-based materials, the coating of metallic surfaces (metal coating), the coating and painting of asphaltic or bituminous coverings, the painting and sealing of various surfaces of plastics (plastics coating), and also as high-gloss varnishes.

A preferred use of the coating materials of the invention, however, is the production of soft feel effect paints, which ensure good hydrolysis resistance in conjunction with very good tactile properties. Such coating materials are used preferably in the painting of plastics or of wood, where curing takes place normally at temperatures between room temperature and 130° C. The two-component technology with non-blocked polyisocyanates as crosslinkers allows the use of comparatively low curing temperatures within the aforementioned range.

Accordingly soft feel paints comprising the coating materials of the invention are also provided by the present invention.

The aqueous coating materials of the invention are usually used in single-coat paints or in the clearcoat or topcoat film (topmost film) of multi-coat systems.

The coating can be produced by any of a wide variety of spraying methods such as, for example, air-pressure spraying, airless spraying or electrostatic spraying methods, using one-component or, where appropriate, two-component spraying units. The paints and coating materials comprising the binder dispersions of the invention can alternatively be applied by other methods, such as for example by brushing, rolling or knife coating.

The present invention likewise provides a multi-coat system characterized in that the topmost coat, which is a clearcoat or topcoat, comprises a soft feel paint comprising the coating materials of the invention.

### EXAMPLES

Unless indicated otherwise, all percentages are to be understood as referring to percent by weight.

Substances and abbreviations used:

Diaminosulphonate: NH₂—CH₂CH₂—NH—CH₂CH₂—SO₃Na (45% in water)

Bayhydrol® XP 2429: Aliphatic hydroxyl-functional polyester-polyurethane dispersion with a solids content of 55% (Bayer AG, Leverkusen, DE)

Bayhydrol® XP 2441: Aliphatic hydroxyl-functional polyester-polyurethane resin, 75% in N-methylpyrrolidone (Bayer AG, Leverkusen, DE)

Desmophen® 2020: Polycarbonate polyol, OH number 56 mg KOH/g, number-average molecular weight 2000 g/mol (Bayer AG, Leverkusen, DE)

PolyTHF® 2000: Polytetramethylene glycol polyol, OH number 56 mg KOH/g, number-average molecular weight 2000 g/mol (BASF AG, Ludwigshafen, DE)

PolyTHF® 1000: Polytetramethylene glycol polyol, OH number 112 mg KOH/g, number-average molecular weight 1000 g/mol (BASF AG, Ludwigshafen, DE)

Polyether LB 25: (monofunctional polyether based on ethylene oxide/propylene oxide, number-average molecular weight 2250 g/mol, OH number 25 mg KOH/g (Bayer AG, Leverkusen, DE)

BYK 348: Wetting agent (BYK-Chemie, Wesel, DE)

Tego-Wet® KL 245: Flow additive, 50% in water (Tegochemie, Essen, DE)

Aquacers 535: Wax emulsion (BYK-Chemie, Wesel, DE)

Defoamer DNE: Defoamer (K. Obermayer, Bad Berleburg, DE)

Sillitin® Z 86: Filler (Hoffiann & Sohne, Neuburg, DE)

Pergopak® M 3: Filler, matting agent (Martinswerk, Bergheim, DE)

Talkum® IT extra: Matting agent (Norwegian Talc, Frankfurt, DE)

Bayferrox® 318 M: Colour pigment (black) (Bayer AG, Leverkusen, DE)

OK 412: Matting agent (Degussa, Frankfurt, DE)

Bayhydur® 3100: Hydrophilic, aliphatic polyisocyanate based on hexamethylene diisocyanate (HDI) with an isocyanate content of 17.4% (Bayer AG, Leverkusen, DE)

Bayhydur® VPLS 2306: Hydrophilically modified, aliphatic polyisocyanate based on hexamethylene diisocyanate (HDI) with an isocyanate content of 8.0% (Bayer AG, Leverkusen, DE)

Desmodur® XP 2410: Low-viscosity aliphatic polyisocyanate resin based on hexamethylene diisocyanate with an isocyanate content of 24.0% (Bayer AG, Leverkusen, DE)

MPA: 1-methoxy-2-propyl acetate

The solids contents were determined in accordance with DIN-EN ISO 3251.

NCO contents, unless expressly stated otherwise, were determined volumetrically in accordance with DIN-EN ISO 11909.

### Example 1

### Comparative Example (Component I)

Bayhydrol® PR 240: anionically hydrophilicized PU dispersion based on polyester with a solids content of 40% and an average particle size of 100-300 nm (Bayer AG, Leverkusen, DE)

### Example 2

### Non-Functional PU Dispersion (Component I)

144.5 g of Desmophen® 2020, 188.3 g of PolyTHF® 2000, 71.3 g of PolyTHF® 1000 and 13.5 g of polyether LB 25 are heated to 70° C. Subsequently at 70° C. over the course of 5 minutes a mixture of 59.8 g of hexamethylene diisocyanate and 45.2 g of isophorone diisocyanate is added and the mixture is stirred under reflux until the theoretical NCO value is reached. The finished prepolymer is dissolved with 1040 g of acetone at 50° C. and subsequently a solution of 1.8 g of hydrazine hydrate, 9.18 g of diaminosulphonate and 41.9 g of water is metered in over the course of 10 minutes. The subsequent stirring time amounts to 10 minutes. Following the addition of a solution of 21.3 g of isophoronediamine and 106.8 g of water, dispersion is carried out over the course of 10 minutes by addition of 395 g of water. This is followed by removal of the solvent by vacuum distillation to give a storage-stable dispersion having a solids content of 50.0%.

Using examples 1-2, the following performance tests are conducted into the production of soft feel coatings:

The stock paint is produced, following prior dispersion, by dispersing using a laboratory shaker. The temperature of the millbase ought not to exceed 40° C. Subsequently stir in O412 for about 10 minutes. After crosslinking, the paint system is adjusted to a flow time (DIN ISO 2431, 5 mm nozzle) of about 30 s and sprayed conventionally onto Bayblend® T 65. The dry film coat thickness amounts to between 30 and 40 μm.

TABLE 1
Performance examples 3-8 (inventive)

| | Example | | | | | |
|---|---|---|---|---|---|---|
| | 3 | 4 | 5 | 6 | 7 | 8 |
| Component I: | | | | | | |
| Example 2 | 79.4 | 79.4 | 79.4 | 79.4 | 79.4 | 79.4 |
| Component II: | | | | | | |
| Bayhydrol ®XP 2429 | — | — | — | 72.8 | 72.8 | 72.8 |
| Bayhydrol ®XP 2441 | 52.6 | 52.6 | 52.6 | — | — | — |
| Additives/pigments: | | | | | | |
| Defoamer DNE | 0.5 | 0.5 | 0.6 | 0.5 | 0.5 | 0.6 |
| Tego ® Wet KL 245 | 0.9 | 0.9 | 0.9 | 0.9 | 0.9 | 0.9 |
| Byk ® 348 | 1.4 | 1.3 | 1.4 | 1.4 | 1.3 | 1.4 |
| Aquacer ® 535 | 4.0 | 3.9 | 4.0 | 4.0 | 3.9 | 4.0 |
| Sillitin ® Z 86 | 9.2 | 9.0 | 9.3 | 9.4 | 9.0 | 9.3 |
| Pergopak ® M 3 | 13.8 | 13.5 | 14.0 | 13.9 | 13.6 | 14.0 |
| Talkum IT extra | 4.6 | 4.5 | 4.7 | 4.6 | 4.5 | 4.7 |
| Bayferrox ® 318 M | 36.9 | 36.1 | 37.4 | 37.0 | 36.2 | 37.4 |
| OK 412 | 4.6 | 4.5 | 4.7 | 4.6 | 4.5 | 4.7 |
| Water, demineralized | 104.8 | 96.5 | 103.4 | 66.3 | 65.2 | 73.2 |
| Total | 312.7 | 302.7 | 312.4 | 294.8 | 291.8 | 302.4 |
| Flow time ISO 5 cup | 27 s | 31 s | 31 s | 25 s | 29 s | 29 s |
| (test specification 01) | | | | | | |
| pH (test specification | 7.2 | | | 7.2 | | |
| KCS 5.02.07) | | | | | | |
| Component III: | | | | | | |
| Bayhydur ® 3100, | 16.4 | — | — | 16.5 | — | — |
| 75% in MPA | | | | | | |
| Bayhydur ® XP 2487, | — | 12.9 | — | — | 13.0 | — |
| 80% supply form | | | | | | |
| Bayhydur ® VP LS 2306: | — | — | 17.9 | — | — | 18.0 |
| D'dur XP 2410 (1:1), | | | | | | |
| 75% in MPA | | | | | | |
| 100 g comp. A: comp. B | 5.2 | 4.3 | 5.7 | 5.6 | 4.4 | 5.9 |

| | |
|---|---|
| NCO/OH ratio | 1.5 |

Application conditions: about 23° C. and 55% relative humidity.
Drying conditions: 10 min/RT, 30 min/80° C. and about 16 h/60° C. ageing

TABLE 2
Performance examples 9-14 (comparative examples)

| | Example | | | | | |
|---|---|---|---|---|---|---|
| | 9 | 10 | 11 | 12 | 13 | 14 |
| Component I: | | | | | | |
| Example 1 | 100.0 | 100.0 | 100.0 | 100.0 | 100.0 | 100.0 |
| Component II: | | | | | | |
| Bayhydrol ®XP 2429 | — | — | — | 72.8 | 72.8 | 72.8 |
| Bayhydrol ®XP 2441 | 52.6 | 52.6 | 52.6 | — | — | — |
| Additives/pigments: | | | | | | |
| Defoamer DNE | 0.5 | 0.5 | 0.6 | 0.5 | 0.5 | 0.6 |
| Tego ® Wet KL 245 | 0.9 | 0.9 | 0.9 | 0.9 | 0.9 | 0.9 |
| Byk ® 348 | 1.4 | 1.3 | 1.4 | 1.4 | 1.3 | 1.4 |
| Aquacer ® 535 | 4.0 | 3.9 | 4.0 | 4.0 | 3.9 | 4.0 |
| Sillitin ® Z 86 | 9.2 | 9.0 | 9.3 | 9.4 | 9.0 | 9.3 |
| Pergopak ® M 3 | 13.8 | 13.5 | 14.0 | 13.9 | 13.6 | 14.0 |
| Talkum IT extra | 4.6 | 4.5 | 4.7 | 4.6 | 4.5 | 4.7 |
| Bayferrox ® 318 M | 36.9 | 36.1 | 37.4 | 37.0 | 36.2 | 37.4 |
| OK 412 | 4.6 | 4.5 | 4.7 | 4.6 | 4.5 | 4.7 |
| Water, demineralized | 81.0 | 82.3 | 88.4 | 46.4 | 46.9 | 47.6 |
| Total | 309.5 | 309.1 | 318.0 | 295.5 | 294.1 | 297.4 |
| Flow time ISO 5 cup | 28 s | 29 s | 29 s | 27 s | 29 s | 28 s |
| (test specification 01) | | | | | | |
| pH (test specification | 7.1 | | | 7.0 | | |
| KCS 5.02.07) | | | | | | |
| Component III: | | | | | | |
| Bayhydur ® 3100, | 16.4 | — | — | 16.5 | — | — |
| 75% in MPA | | | | | | |
| Bayhydur ® XP 2487, | — | 12.9 | — | — | 13.0 | — |
| 80% supply form | | | | | | |
| Bayhydur ® VP LS 2306: | — | — | 17.9 | — | — | 18.0 |
| D'dur XP 2410 (1:1), | | | | | | |
| 75% in MPA | | | | | | |
| 100 g comp. A: comp. B | 5.3 | 4.2 | 5.6 | 5.6 | 4.4 | 6.0 |

| | |
|---|---|
| NCO/OH ratio | 1.5 |

Application conditions: about 23° C. and 55% relative humidity.
Drying conditions: 10 min/RT, 30 min/80° C. and about 16 h/60° C. ageing

TABLE 4
Hydrolysis resistance after 72 h at 90° C.
and about 90% relative humidity

| | | | | After 72 h hydrolysis and | | | |
|---|---|---|---|---|---|---|---|
| | 0 value | | | 1 h regeneration at RT | | | |
| Exam- | P hard- | | Soft- | P hard- | | Soft- | |
| ple | ness¹ | CC² | ening³ | ness¹ | CC² | ening³ | Visual⁴ |
| 3 | HB | 2 | 0 | B | 0-1 | 0 | 0 |
| 4 | H | 2 | 0 | B | 1 | 0 | 0 |
| 5 | H | 1-2 | 0 | B | 1 | 0 | 0 |
| 6 | HB | 2 | 0 | B | 1 | 0 | 0 |
| 7 | HB | 2 | 0 | B | 1 | 0 | 0 |
| 8 | H | 2 | 0 | B | 0-1 | 0 | 0 |
| 9 | H | 2 | 0 | 6B | 0-1 | 5 | 1 |
| 10 | HB | 1-2 | 0 | 5B | 0-1 | 5 | 2 |
| 11 | HB | 2-3 | 0 | 6B | 0-1 | 5 | 2 |
| 12 | HB | 2 | 0 | 6B | 1 | 5 | 3 |
| 13 | HB | 2 | 0 | 6B | 1 | 5 | 3 |
| 14 | H | 2-3 | 0 | 6B | 0 | 5 | 3 |

¹Pencil hardness testing:

The pencil hardness method is a test to determine the paint film hardness.

Pencils differing in hardness (6B to 7H) are tested on painted specimens as follows at room temperature: the tip of the pencil is ground horizontally so as to give a planar, circular area. At an angle of 45° the pencil is then pushed over the paint film under test, in the course of which the force applied ought to remain as constant as possible. The pencil hardness value is determined when the paint surface shows damage for the first time.

²Determined in accordance with DIN EN ISO 2409 (O=best value, 5 =worst value)

³Test of film softening (fingernail test):

The film softening is determined by means of the film nail test. The assessment of softening by the fingernail test is as follows:
not scratchable=0 (best value); scratchable down to the substrate=5 (worst value)

⁴0=satisfactory; 1=isolated light marks; 2=light marks; 3=many light marks

The results from Table 4 demonstrate that not only the inventive coatings (examples 3-8) but also the comparison coatings (examples 9-14) possess excellent tactility and approximately the same coating hardness. After 72 h of hydrolysis at 90° C. and 90% relative humidity, however, the comparative examples exhibit considerable film softening (degradation owing to hydrolysis), whereas the coatings from the inventive examples 3-8 exhibit no softening at all.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Aqueous coating material comprising
(I) hydroxyl-free polyurethanes and/or polyurethane-ureas based on polycarbonate polyols and polytetramethylene glycol polyols,
(II) ionically modified, hydroxyl- and/or amino-containing polyurethanes and/or polyurethane-ureas and
(III) at least one crosslinker, and
(IV) optionally further film-forming resins.

2. Coating material according to claim 1, wherein component (II) is a polyurethane polymer based on a polyester urethane and/or on a polycarbonate polyol.

3. Coating material according to claim 1, wherein the polyurethane polymer (I) comprises a combination of ionic and non-ionic hydrophilicizing agents.

4. Coating material according to claim 1, wherein the polyurethane polymer (I) comprises a combination of non-ionic and anionic hydrophilicizing agents.

5. Coating material according to claim 1, wherein the polyurethane polymer (II) has a pure ionic hydrophilicization.

6. Coating material according to claim 1, wherein the polyurethane polymer (II) has a number-average molecular weight Mₙ of 1000 to 30 000, an acid number of 10 to 80 mg KOH/g and an OH content of 0.5% to 6% by weight.

7. Coating material according to claim 1, wherein the crosslinker (III) is a polyisocyanate having free isocyanate groups based on aliphatic or cycloaliphatic isocyanates.

8. Process for preparing the aqueous coating materials according to claim 1, wherein the PU polymers (I) and also the PU polymers (II) are dispersed in water and mixed with the crosslinker (III) and also optionally with the film-forming resins IV).

9. Process for preparing the aqueous coating materials according to claim 1, wherein the PU polymers (II) are present as a solution in a water-miscible solvent which is inert towards isocyanate groups and are transferred to the aqueous phase by being introduced into the PU dispersion (I) and then are mixed with the crosslinker (III) and optionally with the film-forming resins IV).

10. Process according to claim 1, wherein the ratio of the crosslinker III) to the compounds of components II) and optionally IV) that are reactive with it is to be chosen so as to result in a ratio of crosslinker-reactive groups from II) and IV) to the reactive groups of the crosslinker of 0.5:1.0 to 3.5:1.0.

11. Two-component paint comprising the coating materials according to claim 1.

12. A method of coating a surface, the method comprising the step of applying the coating material of claim 1 to a surface, wherein the surface is selected from the group consisting of mineral building materials, metal, an asphaltic or bituminous covering, wood, wood-based materials, and plastic, and any combination of these.

13. Use of the coating materials according to claim 1 for producing soft feel paints on plastics substrates or wood substrates.

14. Soft feel paint comprising the coating materials according to claim 1.

15. Multi-coat system characterized in that the topmost coat, which is a clearcoat or topcoat film, comprises a soft feel paint according to claim 12.
